(19) United States
(12) Patent Application Publication
(10) Pub. No.: US 2004/0040197 A1
(43) Pub. Date: Mar. 4, 2004

(54) Securing device for rod and reel, for automatically hook setting a fish

(76) Inventor: Donald L. Black, Knoxville, TN (US)

Correspondence Address: M. Alex Brown, Esq., Patent Attorney, P.O. Box 70501, Knoxville, TN, 37938-0501, US

(21) Appl. No.: 10/234,232

(22) Filed: Sep. 3, 2002

(51) Int. Cl. A01K 97/12

(52) U.S. Cl. 43/15

(57) ABSTRACT

A set device rod holder for hook setting a fish is disclosed which is installable on diverse types of surfacing and used in interaction with various types of fishing rods for supporting a rod in a set positioning to respond automatically to pressure from an interested fish to hook-set such a fish, and to allow the user to easily pick up the rod and reel in the fish. A platform assembly is provided having at least two base members which are hinged together. The first base is dimensioned or weighted to extend beyond the magnitude of the second base and is utilized in a counter-balancing manner to tip or move away from the second base. Augmentation of the counterbalancing is facilitated by the placement and temporary support of the fishing rod in a placement area on the first base. Embodiments of the invention also utilize biasing elements to further augment the triggering process.

### BACKGROUND OF THE INVENTION

1. Field Of The Invention

The present invention relates to a fishing rod holding device installable on various surfaces and having a self-biasing mechanism which, when set, can release in response to a tug by a game fish, setting a hook at the end of a line of a fishing rod supported in the device, in the fish's mouth, and allowing the user to, then, pickup the fishing rod and reel in the game fish.

The technologies over the years in the areas of automatic fish-catchers, self-actuated fish hookers and fishing rod holders, and related devices, have been very crowded.

Some references found which are typical of the prior art in these areas include U.S. patents to Black (the current Applicant) U.S. Pat. Nos. 4,231,178; Valrey, Sr., 6,125,570; Cordova et al., 4,391,059; King, 3,672,085; Gellatly, 4,012,861; Oulman, 4,188,742; Encinias, 3,832,794; Nachtsheim et al., 6,195,928; Coon et al., 5,076,001; Bourquin et al., 4,193,220; McLeod, 4,290,222; Sizemore, 6,050,020; Gutierrez, 5,359,802; Gallegos et al., 5,245,778; Miller, 4,730,408; Schwend, 4,083,139; Cross, 5,050,332; Timmons, 3,881,269; Sheets, 3,897,646; Strong, Des. 356,141; Tattrie, 5,675,928; Parker, 5,408,779; Cooper, 4,993,181; Hall, 4,679,345; Hahn, 4,522,572; Copeland, 4,471,553; and Sagal, 4,262,440. Many of the devices taught in these references appear to be complicated and expensive to fabricate or manufacture. These references, in structural design, also divert a great amount or magnitude of biasing force or energy away from the prime purpose and are otherwise not directly or concisely responsive to their activating or triggering structures. A number of devices taught in the prior art teach the utilization of a hollow tube, ring or box type structure for receiving or holding the handle portion of a fishing rod or other more forward portions of such a rod; such as Cooper '181, Valrey '570, Cordova '059, Gellatly '861, Oulman '742, Encinias '794, Cross '332, Timmons '269, Coon '001, Nachtsheim '928, Sizemore '020, Gutierrez '802, Schwend '139, and Copeland '553. These inventions employ various distinguishable means of biasing, or providing a force against, such a tube, ring or box; or the fishing rod, or like object, itself, secured therein; in relation to an activating trigger or release mechanism; to force the rod into a position to hook or snag a fish on the end of the fishing rod line in the water.

Many of the prior art references teach intricate or complex spring biasing, rod holding and release or trigger mechanism structures, many of which are further complicated by various adjustable means; such as the Applicant's previously patented invention, Black U.S. Pat. No. 4,231,178; and other devices of this type taught in Miller '408, Gallegos '778, Strong '141, Sheets '646, Parker '779, Hall '345, and King '085.

Additionally, some of the references teach a reliance on engagement with, activation of, or triggering in direct association with, the fishing line of a conventional fishing rod or other similar device; as disclosed in references such as Cooper '181, Coon '001, Gutierrez '802, Schwend '139, Copeland '553, McLeod '222, Miller '408, Gallegos '778 and Sheets '646.

These and other disadvantages, structurally and functionally, of the prior art will become apparent in reviewing the remainder of the present specification, claims and drawings.

Accordingly, it is an object of the present invention to provide a substantially improved and simplified set device rod holder having a substantially enhanced and less complicated structure, and being more cost effective to fabricate or manufacture. A related object of the invention is to provide a counter-balanceable fishing set device rod holder which can optionally function effectively without the use or employment of any spring or biasing means, when so selected.

It is a further object of the present invention to provide a set device rod holder which responds directly to fishing rod line pressure, without the need of specifically engaging or positioning the fishing rod line to activate a triggering assembly.

It is yet a further object of the present invention, in preferred embodiments thereof, to provide a more concise, energy effective and efficient, and biasably responsive, spring and biasing means, structural arrangement and subassembly within the present invention, when selected for utilization and employment by a user, to provide a faster and mechanically smoother response after the device is activated or actuated.

It is a further object to provide a more secure and releasably accessible rod support and holding area, for ease and speed of use when a user desires to pickup or remove a fishing rod from the present device; and which, in preferred embodiments of the present invention, aids in counterbalancing the present device, for hook setting a fish when the option-able spring biasing means is a non-selected feature in certain preferred embodiments of the invention.

It is yet a further object to provide a set device rod holder having a more effective and less complicated, cooperating trigger or activation release clasp subassembly for easier and smoother engagement and release within the present invention; and to provide such a trigger or activation release clasp, in preferred embodiments of the invention, with and without further spring biasing means, for option-able use thereof.

It is yet a further object of the present invention to provide an improved and more efficient two part platform assembly having an improved hinging arrangement, each part in relation to the other; and an improved and more effective biasing and hinging arrangement and structure in preferred embodiments of the invention.

It is a further object to provide a device which is utilizable with any type of rod and reel to set a hook in a fish's mouth; and which is adjustable in terms of the tension provided so that the device can be used and adjusted for trolling and to automatically catch large fish or small fish.

It is yet a further object to provide an automatic rod holder and fish hook setter which can be mounted on many diverse types of installation surfaces such as on shoreline surfacing, and available positions on a tackle box, container or other sports equipment, or vehicle or fishing boat; so that the present device can facilitate fishing, during all of the seasons, all year long.

It is a further object to provide a fishing device which will permit adjustment and counterbalancing through positioning of a rod and reel positionably supported in the device; so that the rod and reel can be positioned fore and aft to adjust the tension necessary to activate or trigger the device, for hook setting a fish, responsively playing a fish and holding a fish until a user can reel the fish in.

It will, therefore, be understood that substantial and distinguishable structural and functional advantages are realized in the present invention over the prior art devices; and that the present invention's simplicity and efficiency of structure, diverse utility, and broad user-friendly functional applications serve as important bases of novelty and distinction in this regard.

### SUMMARY OF THE INVENTION

The foregoing and other objects of the invention can be achieved with the present invention, device and assembly which is a set device rod holder for hook setting a fish which is used in interaction with a fishing rod having a rod, attached reel and hook, bait or lure-provided fishing line issuing from the reel, and in interaction with an installation surface. The invention is provided with a platform assembly having two (2) base members. The first base member is hingeably and pivotably coupled to the second base member. The first base member, in preferred embodiments of the invention, is provided having first and second ends, a midpoint portion generally therebetween, and two generally planar, or other facially configured, surfaces. The first base member is provided with a placement hole extending between and through the first and second planar surfaces. The placement hole further extends, in preferred embodiments, from a position generally proximate to the second end and extending to a position generally disposed at the midpoint portion thereof. The placement hole is utilized in the present invention for receiving an end or handle portion of a fishing rod, and retaining and supporting it so that it can be released and removed when needed.

The present invention is further provided with a prong subassembly means or unit, for releasably securing a rod portion of a fishing rod with which the invention interacts. The prog subassembly is fixed and secured to the first planar surface of the first base member at a position which is generally proximate to the first end thereof.

Also provided as a part of the invention is a clasp member having two planar surfaces and two ends, and having and defining at least one groove portion at a position generally proximate to the second end thereof. The clasp member is pivotably and movably mounted and attached at the second end of the clasp member, to the second base member of the invention.

Further provided as a part of the present invention is a securement member attached at a position generally proximate to a position between the first end and the midpoint portion of the first base member of the invention.

The groove portion of the clasp member is selectively positioned to engage and be secured by the securement member. In this manner, therefore, when a fish strikes or tugs on a fishing line placed into the water such as a lake, ocean, gulf, river or stream having game fish; from a fishing rod secured in the placement hole of the first base member of the invention; the groove portion of the clasp member is released from the securement member; and the first base member is briskly pulled away from the second base member of the invention, by virtue of the biasing forces at work, hook setting a fish and allowing a user to quickly pick up a fishing rod secured in the placement hole of the first base member, and reel in the fishing line on the rod's reel.

The present invention is also, in part, provided as a releasably biasable set device rod holder and automatic fish catching device, for support and interaction with a conventional fishing rod outfit for use in water areas, and spring loadably engaging such a supported fishing rod outfit for the functional purposes of hook setting a game fish that strikes or pulls on a fishing line in a game water area. In a broader sense the present invention is provided with a platformed trap set assembly having first and second base members and means for hingeably and pivotably connecting and moving the first base member in positional relation to the second base member. The first base member is provided with at least first and second ends, first and second surfaces and first and second side portions; and the second base member is provided with at least first and second ends, first and second surfaces and first and second side portions. The first base member has and defines a rod placement hole extending between the first and second surfaces of the first base member; and is provided with means for releasably and biasably retaining an elongate object therewithin; which comprises first and second prong members, where each of the prong members is pivotably biased and coupled in relation to each other. This means is securely fixed and attached to the first surface of the first base member of the invention.

A clasp member, defining and having at least one looped portion and first and second ends, is pivotably and movably mounted onto the second base member.

The invention in preferred embodiments thereof is also provided with means for setably and releasably receiving the clasp member, which is positioned on the first base member generally proximate to the first end and first and second surfaces of the first base member of the invention. The second base member of the invention further defines and is provided with means for securing the second base member to a selected installment surface with which the present invention interacts.

In other preferred embodiments the present invention is provided with optionally selectable and utilizable spring or biasing means, connecting and interacting between the invention's first and second base members, to augment and intensify the weight-counter-balanceable characteristics of the invention and assist in hook setting and playing a fish until it can be reeled in.

### BRIEF DESCRIPTION OF THE DRAWINGS

FIG. 1A is a side perspective view of one preferred embodiment of the novel set device rod holder of the present invention illustrating the invention in a set or armed position; and a mounted and stored biasing member on one of the invention's base members, for optional use with the adjoining base member. The broken lines in this and other drawings show both a generic installation surface or surfacing and a generic fishing rod; with which the present invention interacts.

FIG. 1B is an elevated perspective view of the bottom portions of another preferred embodiment of the novel set device rod holder of the present invention, shown in the open or non-set position.

FIG. 2A is a side perspective of the embodiment of FIG. 1A showing the present invention in an open, triggered or sprung position; and illustrating a mounted optional-use biasing member on one of the base members of the invention.

FIG. 2B is a side elevated perspective showing another preferred embodiment of the present invention; and illustrating a mounted biasing member stored for optional use, when selected by a user, with the adjoining lower base member.

FIG. 2C is an elevated perspective view of top portions of the set device rod holder of FIG. 1B, shown in the open or non-set position.

FIG. 3A is a side view of another embodiment of the invention which utilizes no biasing members, but relies on counter-balancing weight and force; showing the hook setter of the present invention in an armed, ready or cocked position.

FIG. 3B is a further side view of the invention of embodiment of the invention of FIG. 3A, showing the device in a triggered, open or sprung position based on the counter-balancing force, weight and principles designed into the present invention in preferred embodiments thereof.

FIG. 3C is an elevated perspective view of bottom portions of another preferred embodiment of the present invention, shown in the open or non-set position; and illustrating the use of a spring biased hinge member.

FIG. 4 is an elevated perspective of top portions of the embodiment of the present invention of FIG. 3C, shown in the open or non-set position.

FIG. 5 is a side view of the embodiment of FIG. 3C, shown in the closed or set position. The fishing rod with which the present invention interacts is shown in broken lines and does not form part of the present invention. The arrow shown indicates the direction in which the clasp of the present invention moves when activated or engaged.

FIG. 6 is an opposing side view of the embodiment of FIG. 5. The arrow shown indicates the direction of one of the base members for the purpose of setting the device. The broken lines are utilized as in FIG. 5.

FIG. 7 is a side view of another preferred embodiment of the set device rod holder of the present invention, shown in the closed or set position. The broken lines indicate a generic installation surface with which the present invention interacts.

FIG. 8 is a side view of the embodiment of FIG. 7, shown in the closed and set position. The partial broken lines illustrate part of the prong subassembly viewable behind the clasp member of the invention, which do form part of the present invention. The further, larger broken lines are utilized as in FIG. 7.

FIG. 9 is a side perspective view of the embodiment of FIG. 7, showing the present device in the closed or set position, and utilizing broken lines as in FIGS. 5 and 7.

FIG. 10 is an opposing side perspective view of the embodiment of FIG. 9, shown in the closed and set position. The broken lines are utilized as in FIGS. 5 and 7.

FIG. 11 is a side perspective view of the embodiment of FIG. 9, showing another open or non-set positioning of the present invention, and utilizing the broken lines as indicated above.

FIG. 12 is a bottom view of the embodiment of FIG. 7, showing the present invention from the bottom in the closed and set position.

FIG. 13 is a bottom view of the embodiment of the set device rod holder of FIG. 7, showing the present invention from the bottom in the open or non-set position.

FIG. 14 is a side view of the embodiment of FIG. 11, from an opposing side showing another open or non-set positioning of the present invention.

FIG. 15 is a front view of another preferred embodiment of the set device rod holder of the present invention, shown in the closed or set position.

FIG. 16 is a front view of the embodiment of FIG. 15, shown in the open or non-set position.

FIG. 17 is a front view of another preferred embodiment of the set device rod holder, shown in the open or non-set position.

FIG. 18 is a front view of the embodiment of FIG. 17, shown in the closed or set position.

FIG. 19 is a top view of the embodiment of FIG. 17, shown in the closed or set position.

FIG. 20 is a side view of the embodiment of FIG. 17, of the present invention, shown in the closed or set position.

FIG. 21 is a side view of the embodiment of FIG. 17, shown in the open or non-set position.

FIG. 22 is a photograph of a bottom view of another preferred embodiment of the present invention, showing the present invention in a closed or set position.

FIG. 23 is a photograph of a front view of the embodiment of FIG. 22, showing the invention in the open or non-set position.

FIG. 24 is a photograph of a side perspective view of the embodiment of FIG. 22, shown in open or non-set position.

FIG. 25 is a photograph of a back or rear view of an enlarged example of the prong subassembly utilized in the embodiment of FIG. 22, and other preferred embodiments of the present invention.

FIG. 26 is a photograph of an enlarged perspective view of the example of FIG. 25.

FIG. 27 is a photograph of an enlarged top view of the example of FIG. 25.

FIG. 28 is a photograph of a top view of the embodiment of FIG. 22, showing the present invention in open or non-set position.

FIG. 29 is a photograph of a side view of the embodiment shown in FIG. 22, showing another open or non-set position of the present invention.

FIG. 30 is a photograph of the opposing side of that shown in FIG. 29, showing the present invention in another open or non-set position.

FIG. 31 is a photograph of an elevated perspective view of the embodiment of FIG. 22, showing the present invention in an open or non-set position.

FIG. 32 is a photograph of a bottom view of an embodiment similar to that of FIG. 17, showing the present invention in a closed or set position, for clarity.

FIG. 33 is a photograph of a front view of an embodiment similar to that of FIG. 17, showing the present invention in an open or non-set position, for clarity.

FIG. 34 is a photograph of a side view of the embodiment of FIG. 33, showing the device in armed or ready position.

### REFERENCE NUMBERS IN DRAWINGS

10 set device rod holder or Hook Setter of the present invention

12 fishing rod (not included as part of the invention, but with which the invention interacts with)

12A rod portion of (12)

12B line portion of (12)

12C reel portion of (12)

12D rod handle portion of (12)

14 installation surface (with which the present invention interacts)

16 platform assembly

18 first base member of (16)

20 second base member of (16)

20A side portion of (20)

20B side portion of (20)

22 pivot hinge

22A flange member of (22)

22B flange member of (22)

24 first end of (18)

26 second end of (18)

27 midpoint portion of (18)

28 first planar surface of (18)

30 second planar surface of (18)

29 side portion of (18)

31 side portion of (18)

32 rod positioning placement hole of (18)

34 adjustable and releasable support prong

40 clasp or trigger clasp

41 planar surface of (40)

42 planar surface of (40)

43 end of (40)

44 end of (40)

46 groove portion of (40)

48 securement fixture

50 biasing and tensioning pull member

51 pull-use fixture

51A mounting fixture

52 attachment hole of (20)

56 clasp biasing member of (40)

58 further biasing member

60 loop clasp or ring trigger clasp (of another preferred embodiment of the present invention)

A looped perimeter of (60)

60B end of (60)

60C end of (60)

68 forward end of (20), or first end of (20)

70 securement groove of (18)

### DETAILED DESCRIPTION OF THE PREFERRED EMBODIMENTS OF THE INVENTION

The following description of the preferred embodiments of the concepts and teaching of the present invention is made in reference to the accompanying drawing figures which constitute preselected, illustrated examples of the structural and functional elements of the invention, among many other examples existing within the true scope and spirit of the present invention.

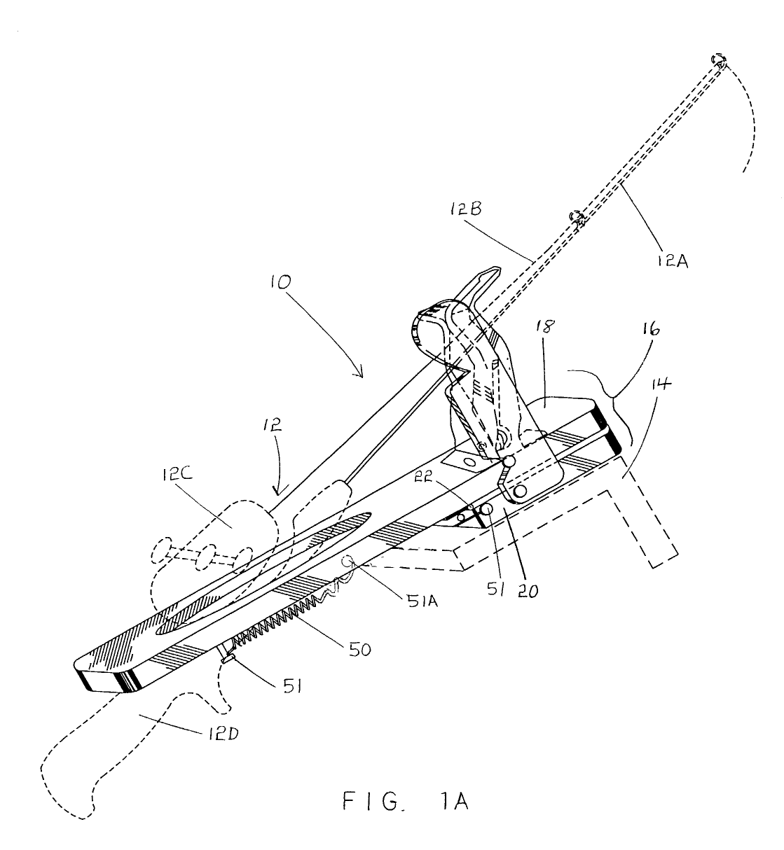

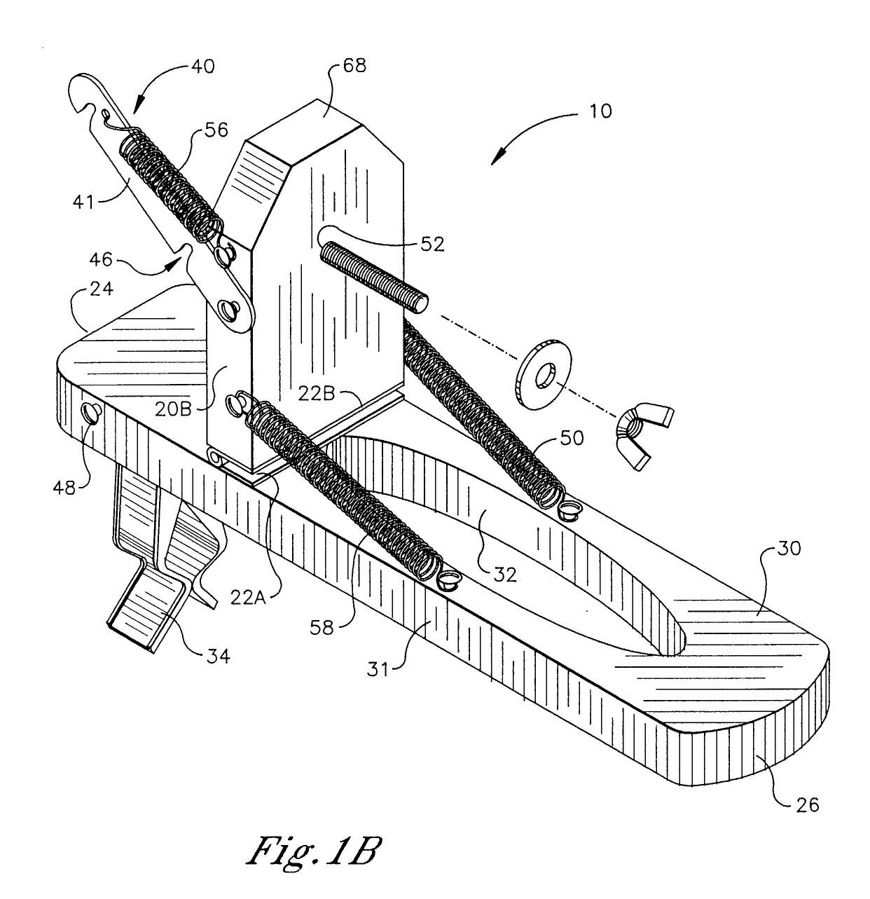

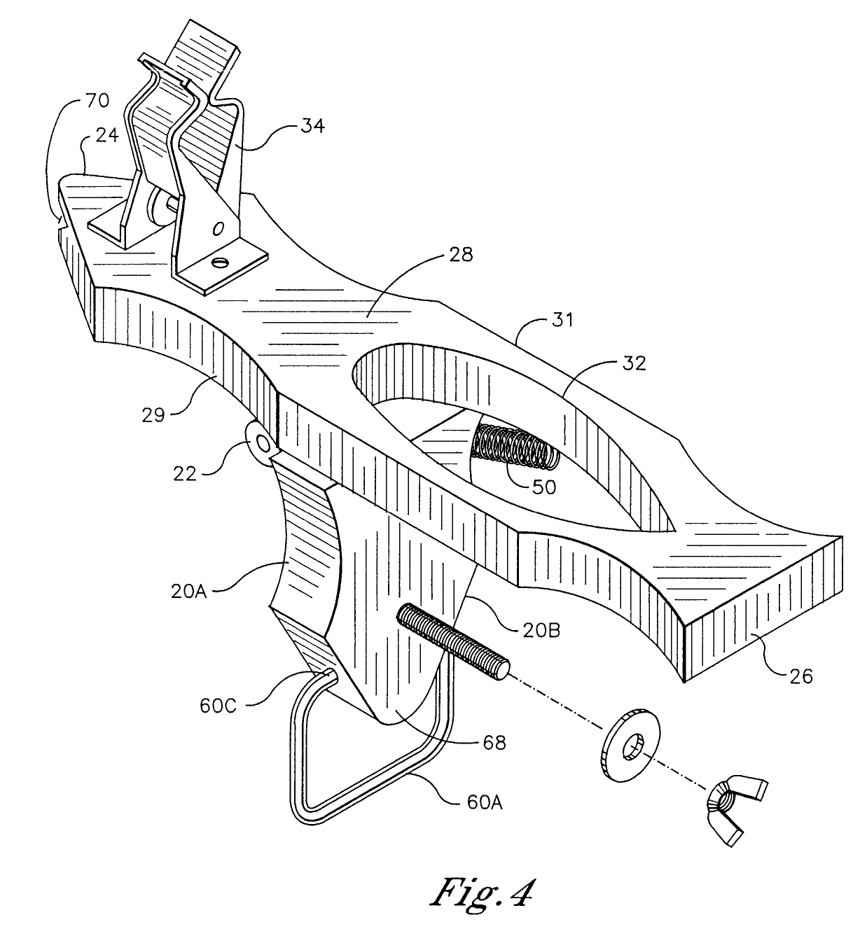

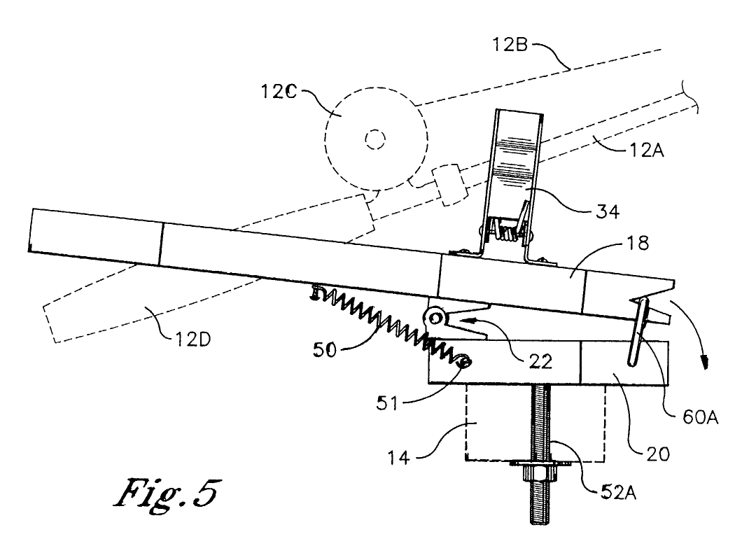

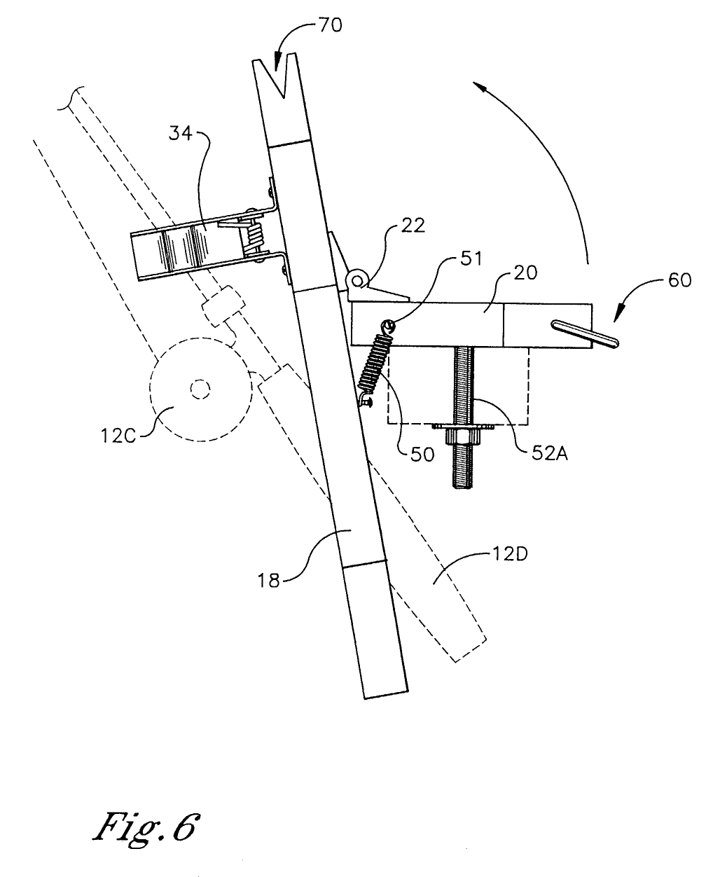

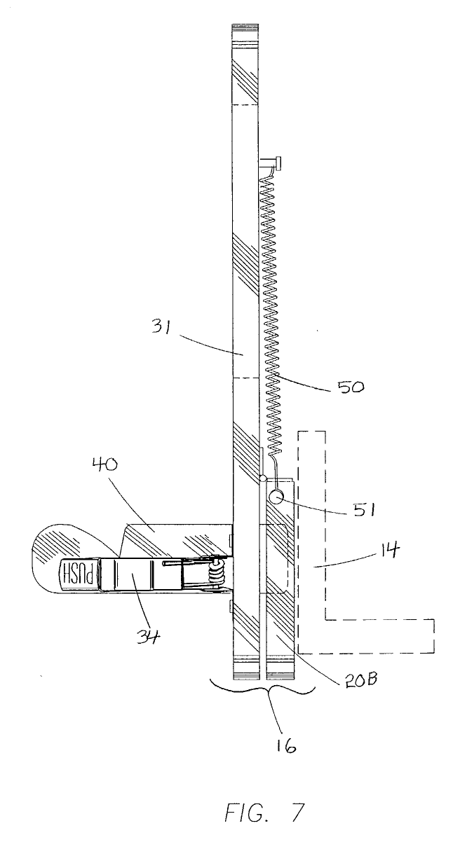

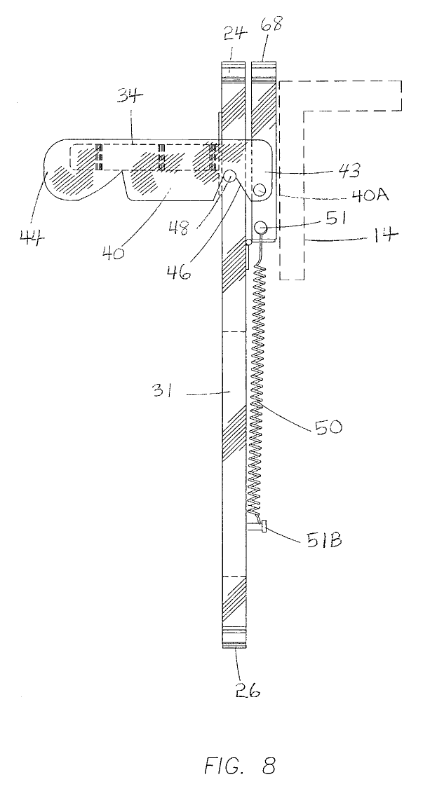

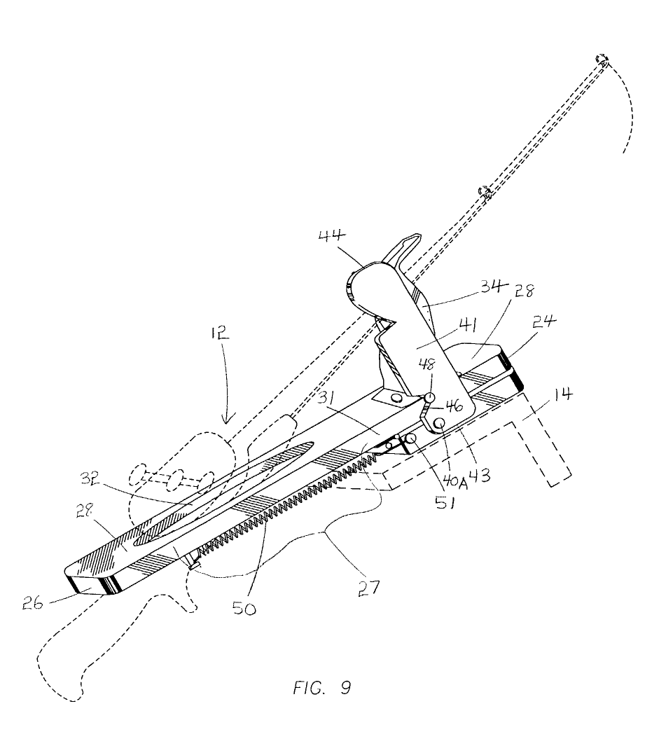

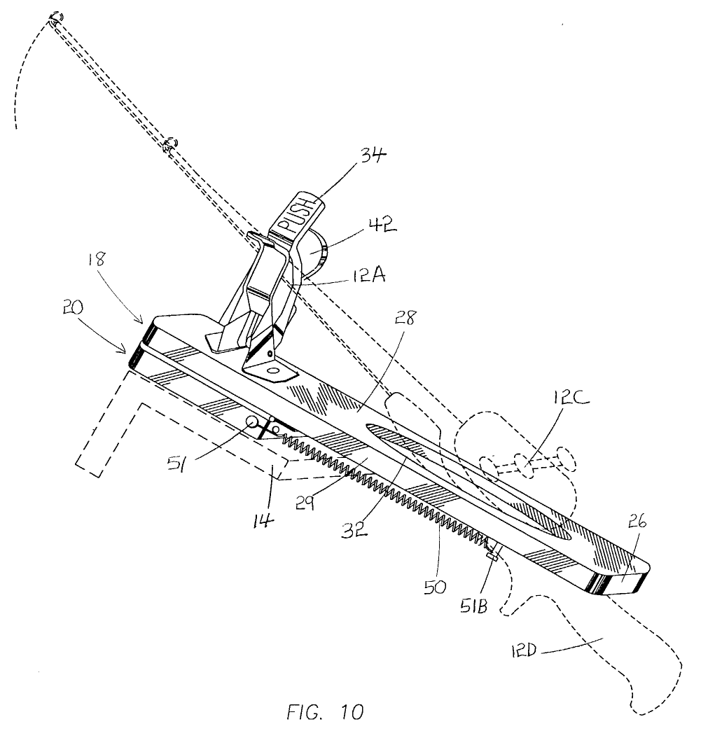

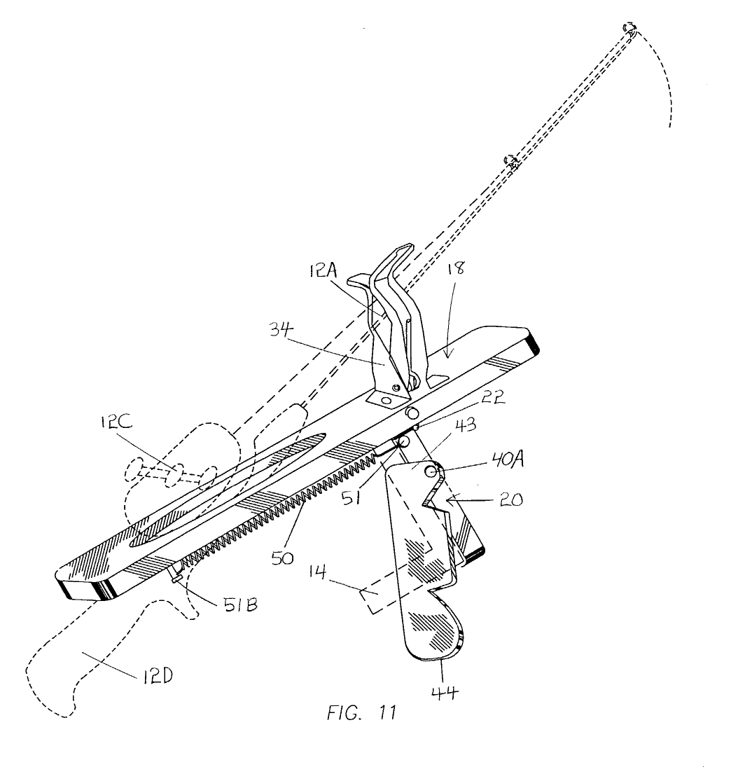

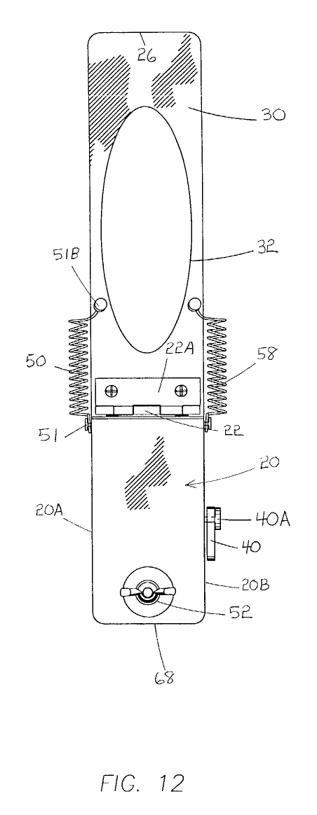

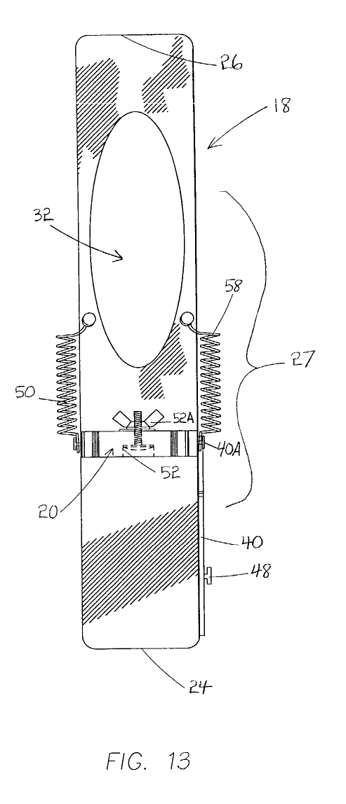

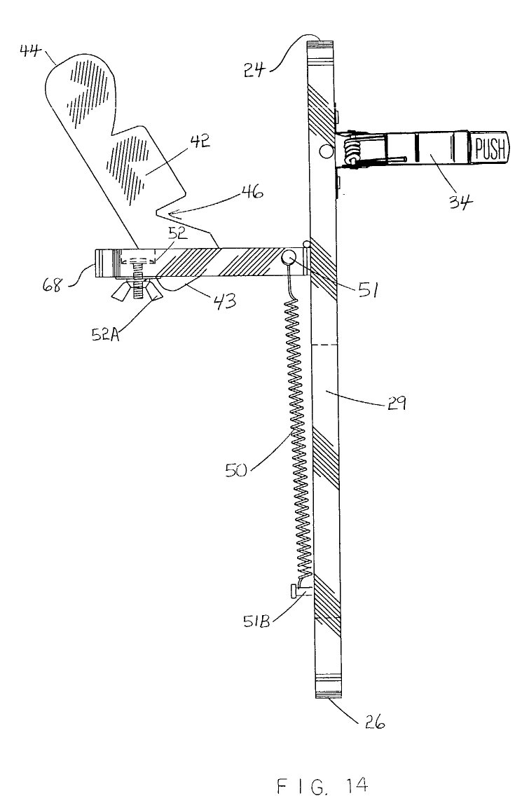

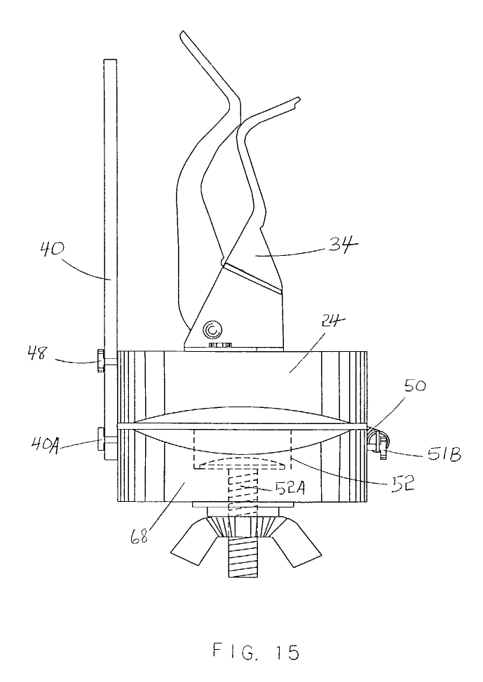

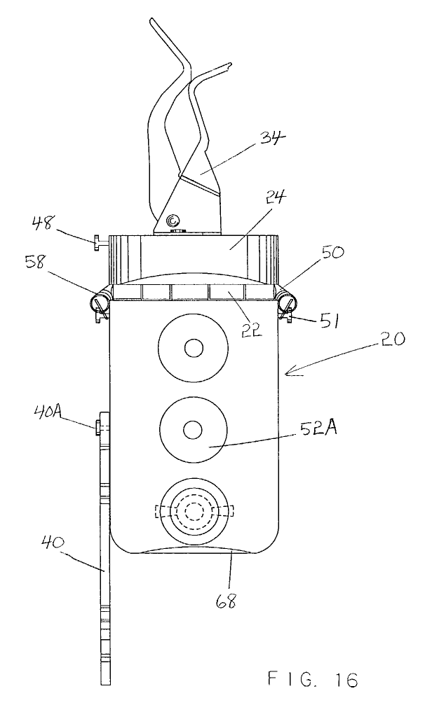

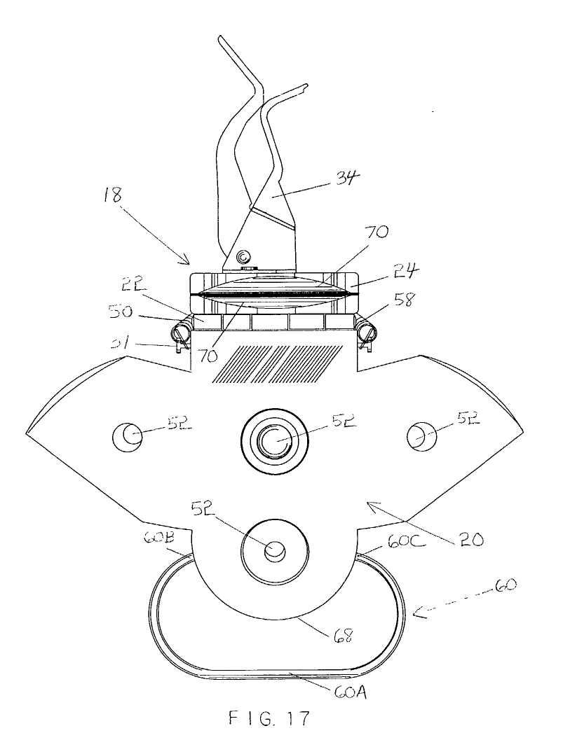

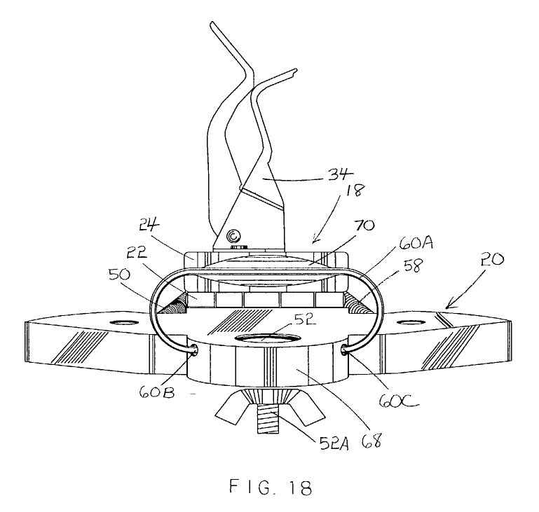

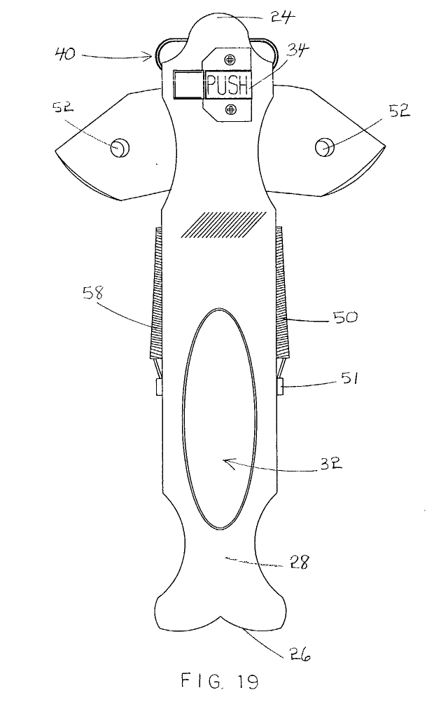

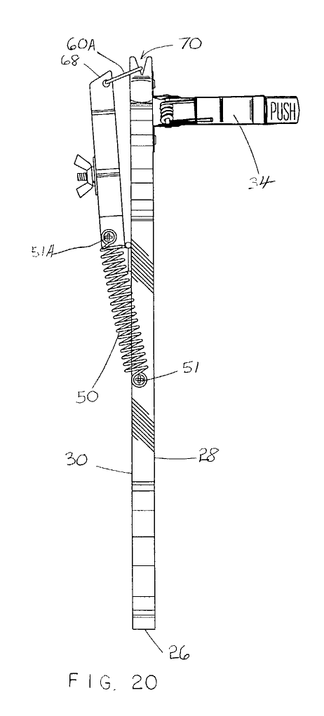

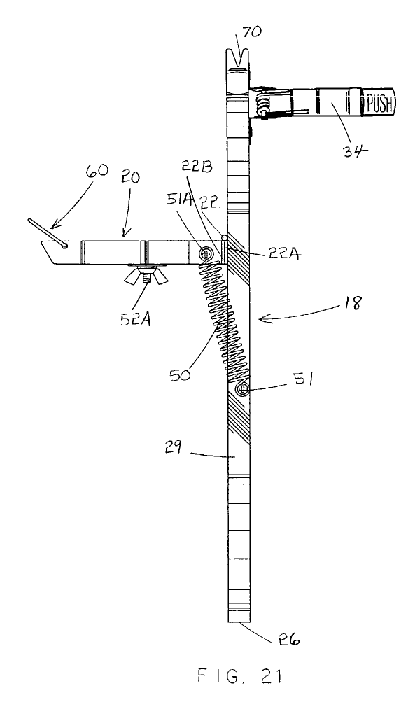

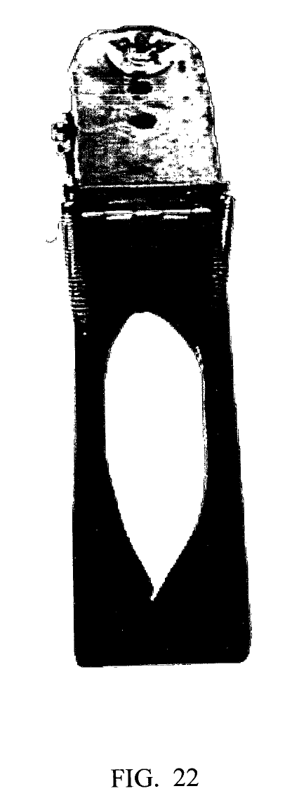

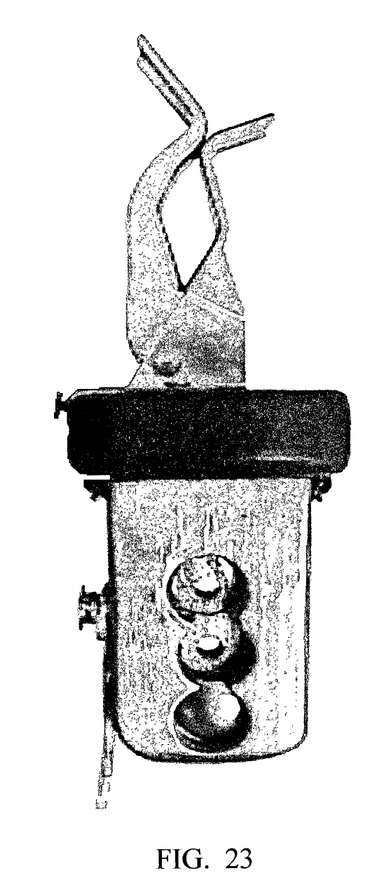

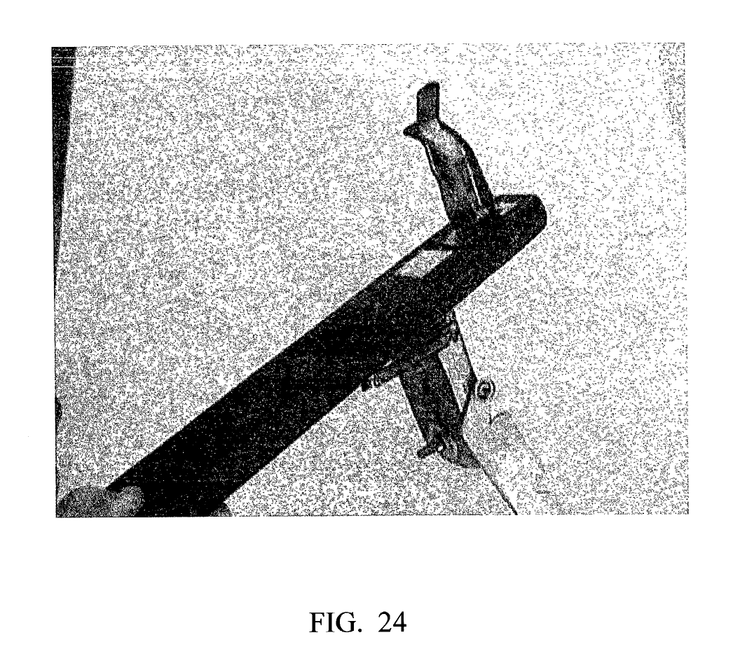

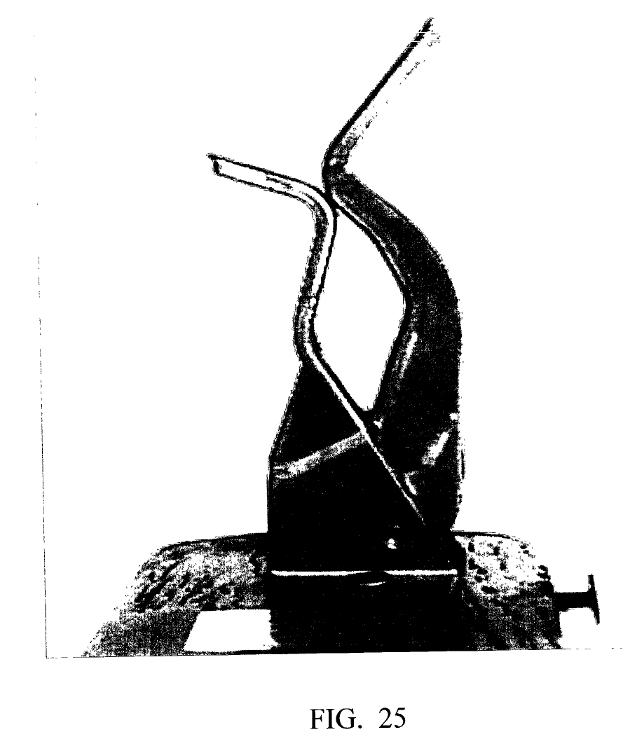

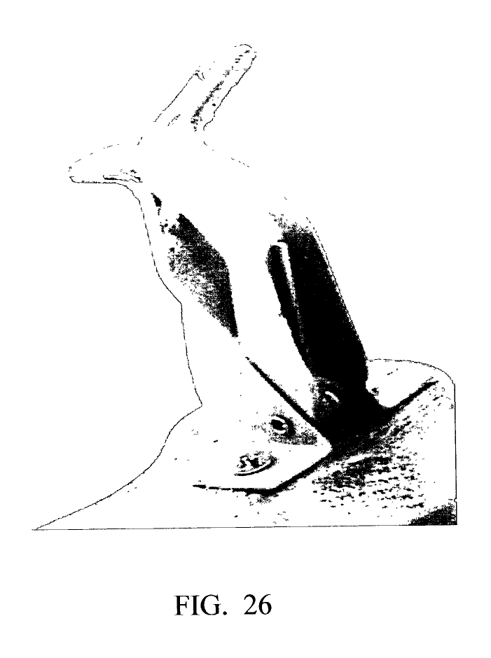

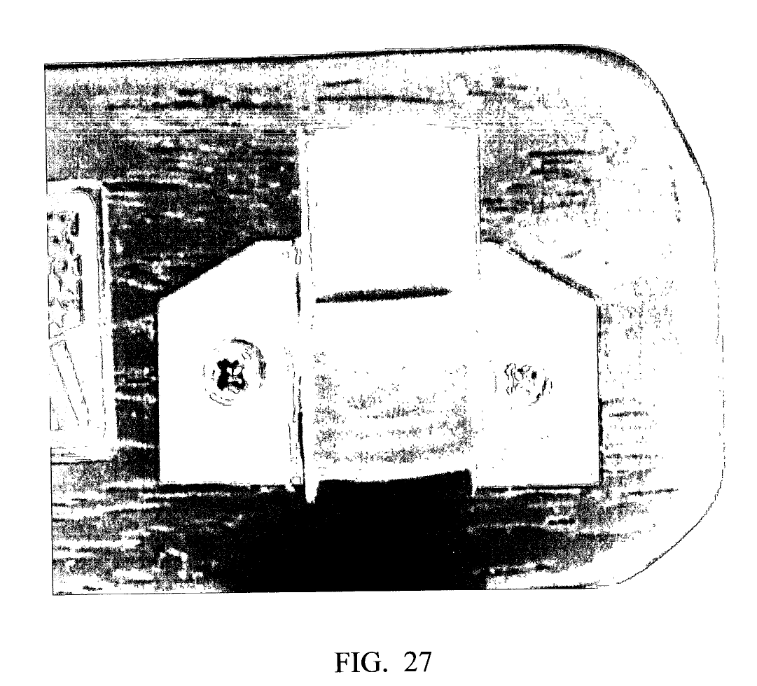

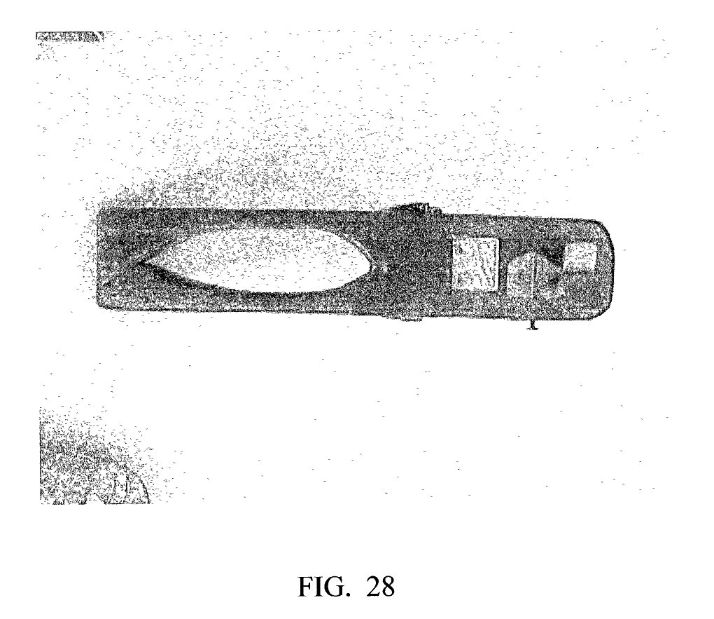

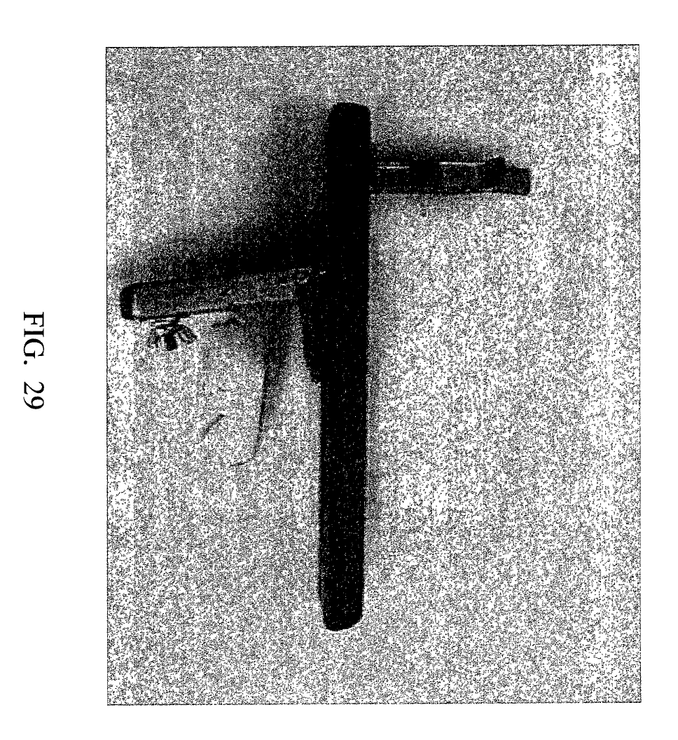

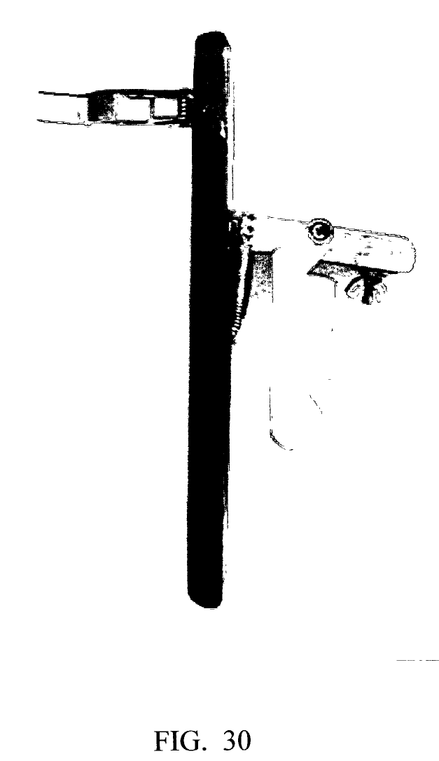

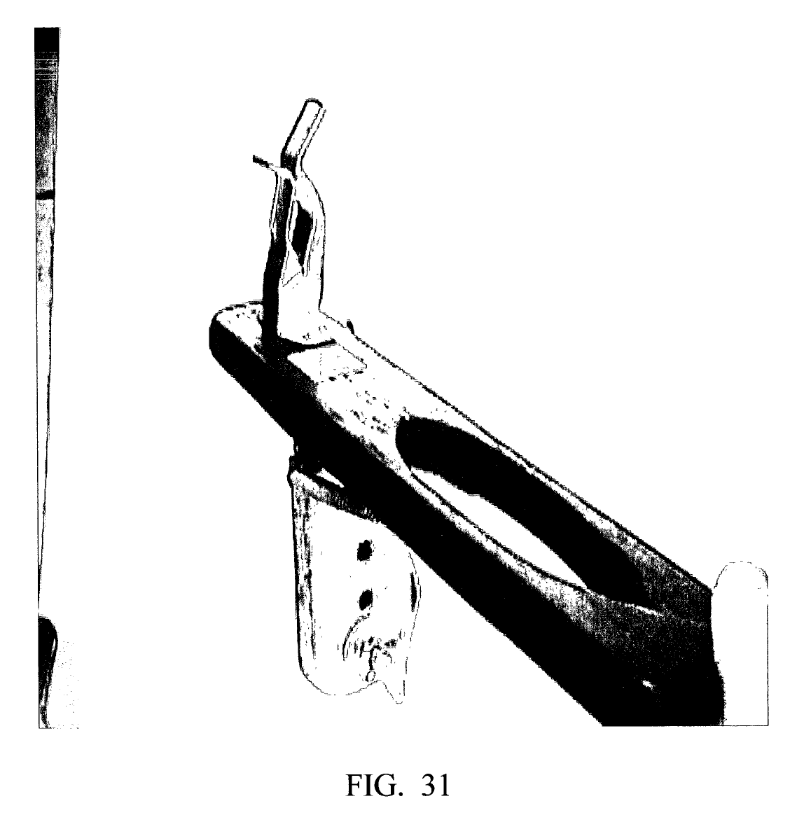

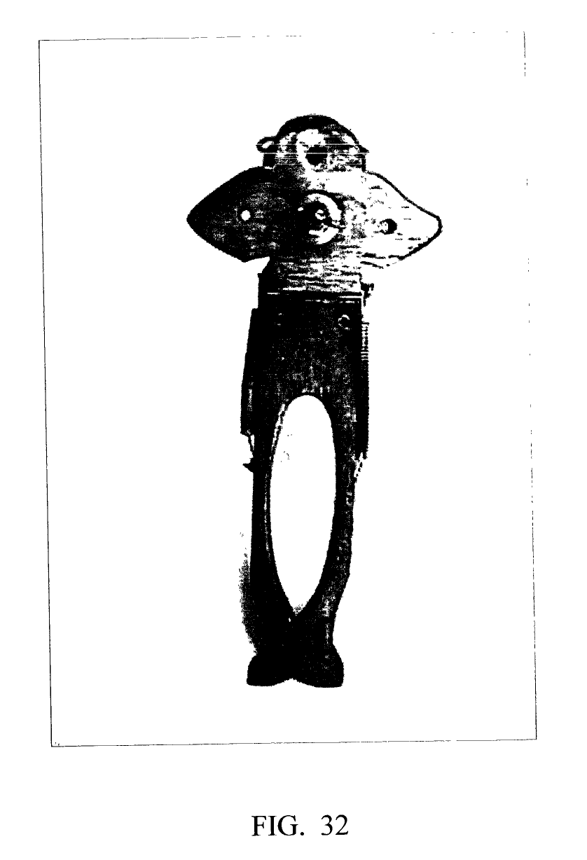

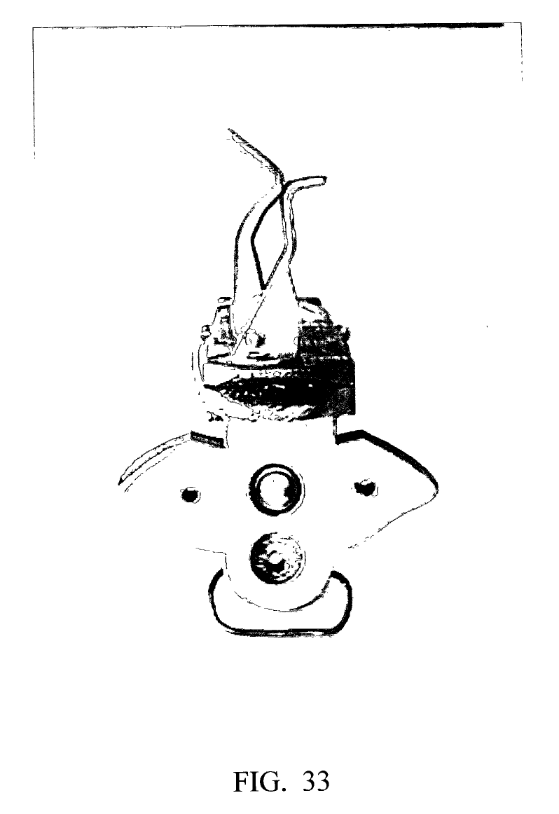

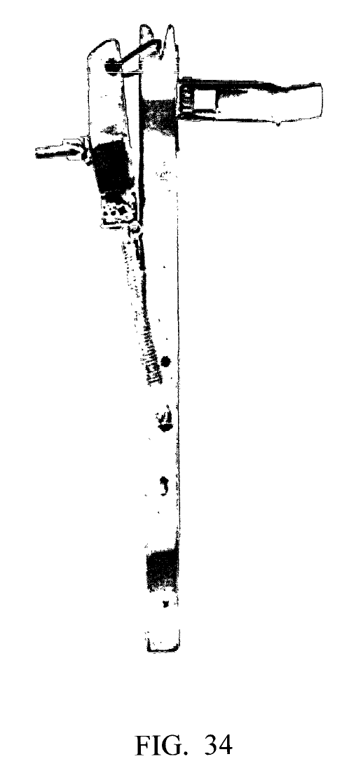

Referring now to the drawings; FIGS. 1A, 1B, 2A, 2C, 3A, 3B, 3C, and 4 through 21; and photographic illustrations, FIGS. 22 through 34; thereof; there is shown a Set Device Rod Holder 10, of the present invention, referred to herein also as the Hook Setter 10.

The Set Device Rod Holder 10 is utilized for hook setting a fish and is used in structural and functional interaction with many diverse and varied types of fishing rods 12, and like devices, having a rod, attached fishing reel and hook, bait or lure-provided fishing line issuing (or coming from) the fishing reel. The Hook Setter 10 is also used in interaction with an installation surface 14 or preselected site or position for placing, securing or setting up the device of the present invention.

In preferred embodiments of the invention the Hook Setter 10 is provided with a platform assembly 16 having its first base member 18 and its second base member 20. The first base 18 is hinged and coupled with the second base 20 by the pivot hinge 22, so that each base member can move and pivot in position in relation to one another. The pivot hinge 22 is attached to the base members 18 and 20 by utilization of the flange members 22A and 22B, or like attachment or connection extensions or means for attachment, normally provided with hinges available on the market which can be utilized as the pivot hinge 22 in the present invention.

The first base 18 is provided having the first end 24, the second end 26, the midpoint portion 27 (located between the ends 24 and 26) and the first planar surface 28 and second planar surface 30. It will be understood within the teachings and concepts of the present invention that it is well within the scope and spirit of the present invention to provide the first and second base members 18 and 20 in many different types of shapes and configurations, and to construct and fabricate these base members having a plurality or number of adjacent or corresponding surfaces or sides in, or having, various linear, planar and curved or arcuate shapes and configurations for use as a part of the present invention.

The first base 18 is also provided with a rod positioning placement hole 32 which, in preferred embodiments, extends between the first planar surface 28 and the second planar surface 30. Opening on both surfaces 28 and 30; as illustrated, by example only, in FIGS. 1A, 1B, 2B, 2C, 4, 10, 12, and a number of other drawing figures and photographic illustrations included herein.

The placement hole 32 further extends lengthwise in positional orientation to the first and second planar surfaces 28 and 30, from a position generally proximate or proximal to the second end 26 of the first base 18, towards the first end 24.

The placement hole 32 is dimensioned to extend a greater dimensional magnitude toward the first end 24 in preferred embodiments of the invention where heavier fishing rods 12 are used in interaction with the present invention; or when it is desired to provide the first base 18 of the platform assembly 16 with greater lengthwise spacing so that a fishing rod 12 can be positioned within the hole 32, with greater lengthwise positional latitude or movement ability, to take advantage of the intrinsic counterbalancing qualities built into the platform assembly 16, and an object, of the present invention.

As illustrated by example, a fishing rod 12 is positioned in the placement hole 32; and the hole 32 is fabricated and shaped so as to allow timely release and procurement of the fishing rod 12, so positioned, when a fish strikes the line, or for volitional or selected reasons.

The Hook Setter 10 is further provided with the adjustable and releasable support prong 34, for securing or supporting a rod portion 12A of a fishing rod 12 so that it can be released and removed from the prong 34 in a timely or quick manner. In preferred embodiments the prong 34 is attached and securely connected to the first planar surface 28 of the first base 18, at a position which is generally proximal or proximate to the first end 24 of the base member 18.

The set device rod holder 10 is further provided with the trigger clasp 40. In preferred embodiments of the invention illustrated by example in FIGS. 1A, 1B, 2A, 2B, 2C, 7, 8, 9, 10, 11, 12, 13, 14, 15, 16, 22, 23, 24, 28, 29, 30 and 31; the clasp 40 is provided with a lengthwise orientation and structural configuration; and having planar surfaces 41 and 42 and ends 43 and 44. The clasp 40 is also provided with the groove portion 46 which is positioned generally close or proximate to the end 43 of the clasp 40. The clasp 40 is movably and pivotably attached or connected near its end 43, to the second base member 20.

The securement fixture 48 is connected or attached to the first base member 18 at a position where it will be available and adjacent to the groove portion 46 when the first and second base member 18 and 20 are brought together for setting the present device and invention. In examples of this positional relationship the securement fixture 48 is shown at a general location along the side portion 29, between the midpoint portion 27 and the first end 24 of the first base member 18 and close to the first end 24 of the base member 18; as shown by example in FIGS. 1A, 2A, 1B, 8, 9, 11, 15, 16, 23, 24, 25, 28, 30 and 31.

The clasp 40 is positioned, moved or pivoted so that the groove portion 46 is brought into secured coupling and engagement with the securement fixture 48; for setting the first base 18 and the second base 20 of the platform assembly 16 in armed and ready position; as shown by example in FIG. 1A, 7, 8, 15 and similar illustrative figures.

Under the installation environment that exists, then, when the present invention is utilized near a water source or site, to automatically hook and set fish; when a fish strikes or tugs on a fishing line 12B placed in a body of water (such as a creek, stream, lake, river, bay, ocean or other water environment or source) from a fishing rod 12 placed and releasably secured in the rod positioning placement hole 32 of the first base member 18; the groove portion 46 of the clasp 40 is released and taken out of coupling or attached positional relationship or register; and the first base 18 is pulled away or separated from the second base member 20 by virtue of the counterbalancing weight dynamics of the first base 18 (in relation and reference to the weight and balance of the second base member 20) as it exists when the first base 18 is housing and supporting the fishing rod 12, and/or by virtue of optional (and selectively employable) biasing, spring, tensioning or pulling members coupled and extending between the first base 18 and the second base 20 (described in greater detail later herein).

As the first base 18 is pulled away and separated from the second base 20, from the tug and force exerted on the fishing line 12B and the resulting release of the groove 46 from the securement fixture 48, and the backward or directional movement of the base 18 away from the base 20, this automatically causes the hook to be set in the fish's mouth (or the hook at the end of the line 12B to be lodged in a fish's mouth); and allows the user to quickly pickup the fishing rod which is releasably housed or positioned in the placement hole 32 of the first basel 18 (now tipped up, back or away from the secured second base 20) and to reel in the fishing line 12B with a fish at the end of the line 12B.

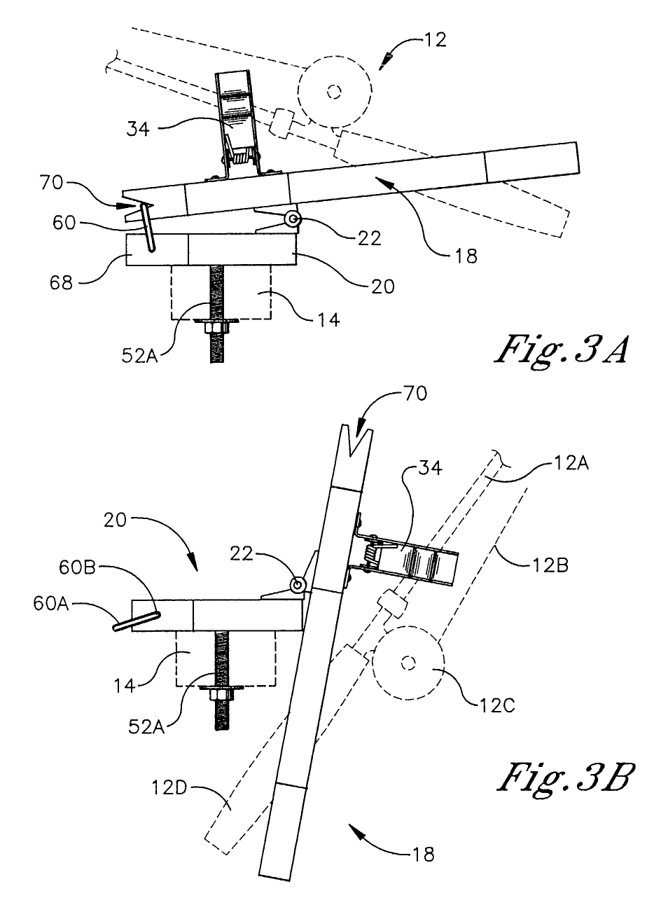

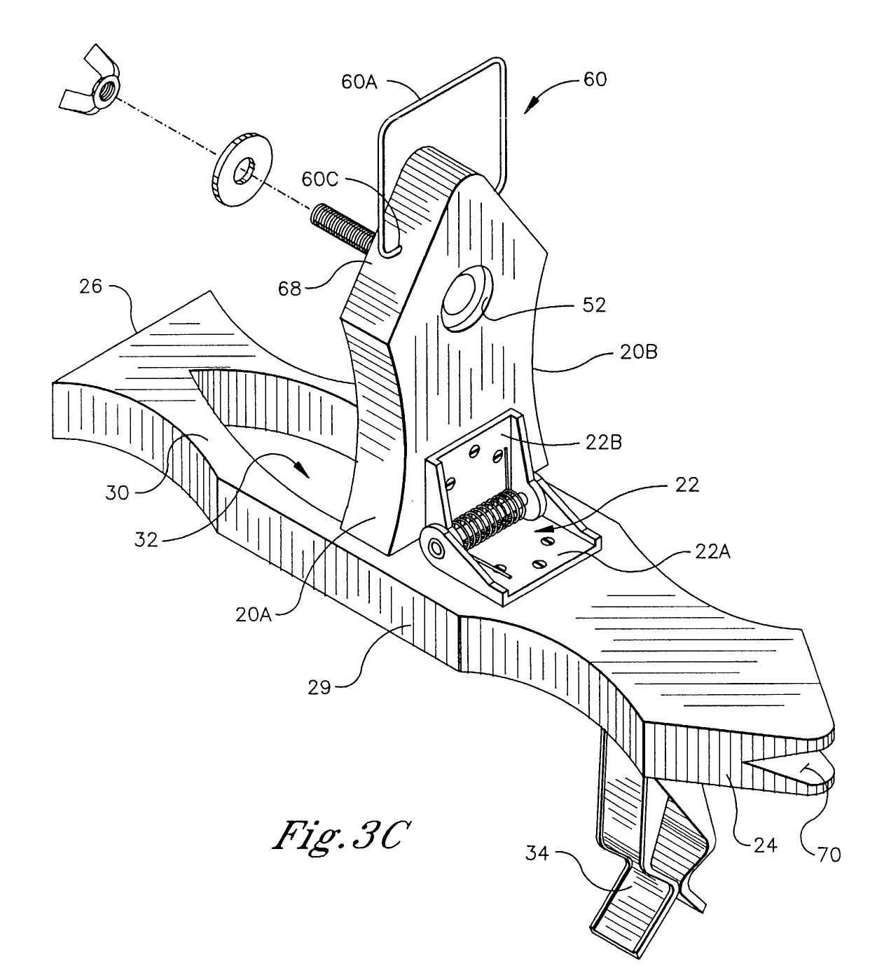

It will be understood that it is well within the scope and spirit of the present invention to provide the first and second base members 18 and/or 20, respectively, in different configurations and shapes, such as a fish-shape (illustrated by example in FIGS. 3A, 3B, 3C, 4, 5, 6, 17, 18, 19, 20, 21, 32, 33 and 34); although a rectangularly oriented, six-sided (or surfaced) shape configuration is utilized in other preferred embodiments of the invention.

Additionally, it is within the scope of the present invention to utilize various configurations in the shape of the placement hole 32 to facilitate the easy and user-friendly mounting, support and releasable housing of a fishing rod 12 or like device, and the timely and quick release, removal and handling of the rod 12 after the device is set and triggered or activated for use as described herein.

In this regard, preferred embodiments of the invention utilize an elliptical, generally rounded fish-shaped, rhomboid or rhombus or diamond-like-four-sided shape or configurational appearance; as illustrated, by example, herein, in FIGS. 1A, 2A, 2B, 1B, 2C, 4, 12, 19, 22, 28 and 32. However, other shape-configurations can be utilized to facilitate easy placement, positioning and removal of a fishing rod 12 which interacts with the present invention, within the scope of the present invention.

Additionally and importantly, the lengthwise and widthwise dimensions of the placement hole 32 are determined within the first base 18, so that the hole 32 is placed and defined within the base 18 to extend in a manner from within the midpoint portion 41 to a position close to the second end 26 of the base 18; so that any fishing rod 12 or like device which is placed within the placement hole 18 can be positioned lengthwise and/or widthwise to concentrate or focus its weight (or the weight of the fishing reel 12C and handle portion 12D of the rod 12) in a manner designed and intended to counterbalance or weigh-down the second end 26 of the first base 18 when the fishing rod handle portion 12D and the reel portion 12C of the rod 12 are positioned and housed in the placement hole 32, as well as for the purpose of easy acquisition of the fishing rod 12.

It is also within the scope of the Hook Setter 10 of the present invention to provide the trigger clasp in a number of shape configurations (and with more than one groove portion 46) for the functional purpose of providing a pivotable, moveable or rotatable clasp member which can be utilized to set and trigger or activate (or actuate) the separation and pulling apart of the first base 18 and the second base 20; although a generally elongated six-surfaced or six-sided, rounded-edge, configuration, with the v-like or u-like-shaped groove portion 46 is illustrated, by example, as preferred embodiments of the present invention.

It will also be understood to be within the scope and spirit of the present invention to provide the securement fixture 48 in many diverse types of members or means; for the purpose of engaging, coupling with or holding the groove portion 46 until it is removed by the force or tug of a fish, and the counter-balancing weight and force of the first base member 18 pulling away from the second base 20 to activate and trigger the Hook Setter 10.

Therefore, various types of cap, catch, head, flange and secured and positioned surfacing can be utilized as the securement fixture 48 for coupling with, catching or holding the groove portion 46 of the clasp 40 to set the present invention for use and automatic response. It will also be understood that the fixture 48 can be provided to release or reject the groove portion 46 on a preselected and volitional basis on the part of the user.

It is also within the scope and spirit of the invention to utilize a number of different dimensional choices and ratio relationships as to each base and between the first base 18 and the second base 20; to facilitate counterbalancing of the first base away from the second base 20.

For example, a lengthwise or elongate dimensional relationship is utilized in preferred embodiments of the invention where the lengthwise dimensional extension of the first base 18 extends about 1.5 (one and one-half) to about 5 (five) times the elongate length of the second base 20, from the point that the bases 18 and 20 are joined or coupled at the hinge 22. Other dimensional relationships (both lengthwise and widthwise) can be employed within the scope, spirit and breath of the present invention to facilitate the functional purposes and objects of the present invention.

By example, the hinge 22 is illustrated as a simple conventional pivoting hinge at FIGS. 1B, 2B, 3A and 3B; and as a tensioned, biased or spring loaded hinge at FIGS. 3C, 4, 5 and 6; with each having flange members 22A and 22B, or like or similar connection extension portions or members. It is also within the scope and spirit of the invention to utilize a number of other different types of pivot hinges 22 (such as diverse types of spring biased, tensional or force-provided hinges or positionally graded or set hinges) to augment and facilitate the movement of the first base 18 in relation to, and away from, the second base 20.

Also, the prong 34 can be provided as a number of types of housing, holding or positioning, or releasable, prongs, or holding-retaining arms or members, which can be separated quickly to release the fishing rod (and particularly the rod portion 12A of the rod 12) from its temporary housing and retainment, for use in reeling in a fish hook set by the present device.

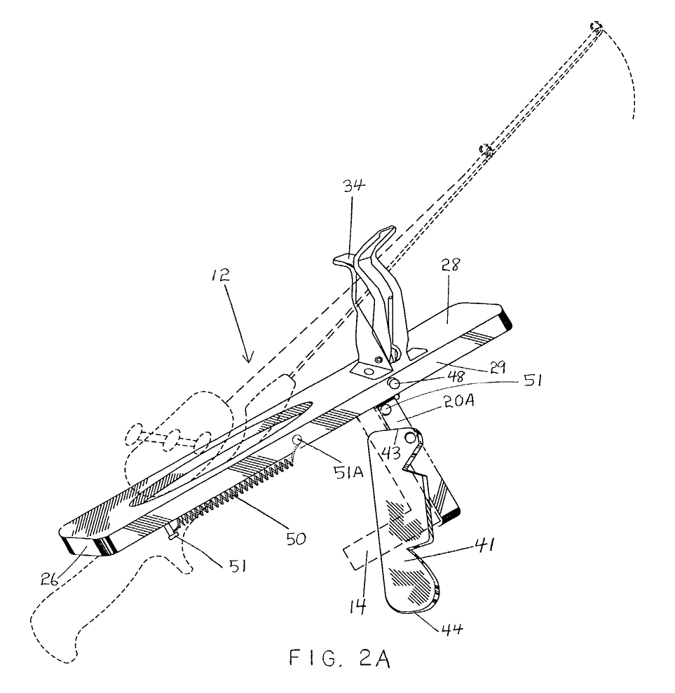

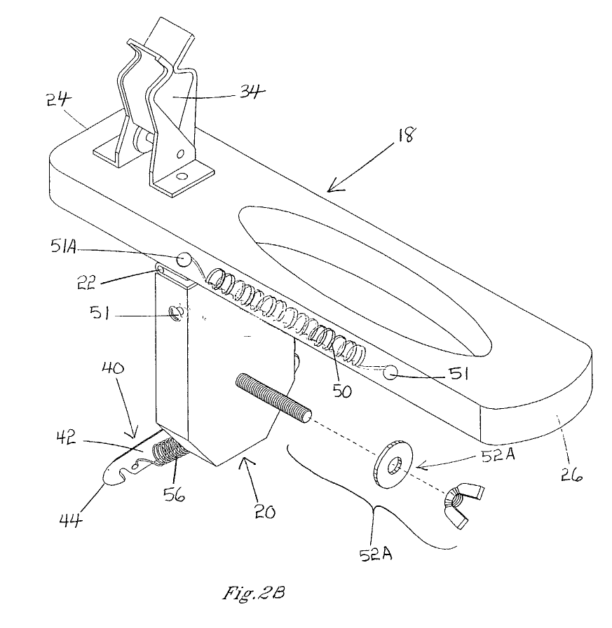

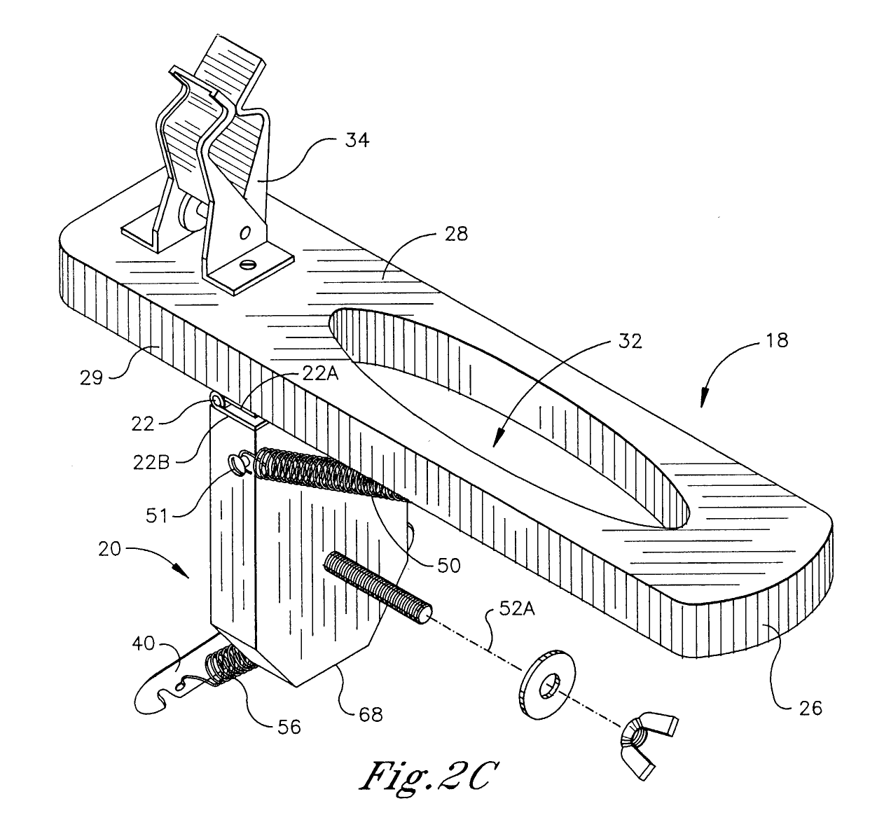

One type of prong 34, illustrated by example, is the self-biasing releasable prong or forked-prong unit which is shown in drawings and photographs such as in FIGS. 2A, 2B, 2C, 3C, 4, 5, 10, 11, 15, 23, 24, 25, 26, 27, 28 and 31. Many other types of units or releasable retaining means can be utilized as the adjustable and releasable support prong 34, positioned at, near, or a short distance away from, the first end 24 of the first base member 18.

In further related preferred embodiments of the invention the Set Device Rod Holder 10 is provided with the biasing and tensioning pull member 50, which is connected to extend between a position on the first base 18 and a position on the second base 20. In some of the preferred embodiments of the present invention, the pull member 50 is mounted and positioned in relation to the first base 18 on the mounting fixture 51A so that it can be utilized on an optional and preselected basis by the user to functionally assist the already existing counterbalancing physical dynamics, described earlier, in pulling the first base 18 and the second base 20 apart form each other upon activation or triggering through release of the clasp 40.

Such mounting and positioning for optional (or option-able) use also includes mounting the pull member 50 on the first base 18 or the second base 20, so that one end of the pull 50 can be releasably disconnected from its mounting fixture 5 1A and attached to a pull-use fixture 51 on the opposing base member. In preferred embodiments, this relationship is illustrated, by example, in FIGS. 1A, 2A, 2B, 3A, 3B, 1B, 2C, 4, 5, 22, 24, 29, 30, 31, 32 and similar drawing and photographic illustrations herein.

In one preferred embodiment, the pull member 50 extends and exerts biasing force and pressure between the second planar surface 30 of the first base 18 at a general position proximate, proximal or close to the placement hole 32, and the second base 20. Other positions for connecting and biasing the first and second base members 18 and 20 can be utilized within the scope of the present invention.

In further preferred embodiments the placement hole 32 of the first base 18 is generally or substantially extended lengthwise along the first base 18 at least one-half of the dimensional magnitude of length of the first base 18.

Also, in preferred embodiments, the second base 20 has and defines an attachment hole 52 (or series of attachment holes) for connecting, coupling or securely attaching the second base 20 to an installation surface with which the Hook Setter 10 interacts. Such an installation surface can be a surface on the ground, or on a water edge, a boat; a piece of fishing equipment such as a fishing-tackle box, fishing pail or seating member; or on a support surface of a dock or shore facility. It will be understood that the second base 20 can be securely attached to such an installation surface (or other similar surfaces) by a number of different securing members, bolts or other attachment and installation means.

Other related embodiments of the present invention utilize the clasp biasing member 56; illustrated, by example, in FIGS. 1B, 2B and 2C; which is attached and connected between the clasp 40 (preferably near one of its ends 43 or 44) and the second base member 20; to augment and facilitate the release of the clasp 40 from the securement fixture 48 when the Hook Setter 10 is activated or triggered by the tug or force of a fish striking or pulling the line 12B of a fishing rod 12 supported in the first base 18.

The Hook Setter 10 is further provided with a further biasing member 58, connected between a position on the first base 18 and a position on the second base 20; as illustrated, by example, in FIGS. 1B, 9, 10, 11, 12, 13, 16, 17, 18, 19, 20, 22, 29, 30 and 32; to augment and facilitate further biasing and force to separate the first and second base members 18 and 20.

Additional preferred embodiments of the Hook Setter 10 of the present invention are illustrated, by example, in FIGS. 3C, 4, 5, 6, 17, 18, 19, 20, 21, 32, 33 and 34.

In these preferred embodiments of the present invention, the Set Device Rod Holder 10 is provided with the Loop Clasp 60 (or Ring Trigger Clasp), for facilitation of the setting and triggering functions of the invention. The loop clasp 60, as illustrated by example, is provided having a loop or looped-configuration perimeter 60A and its first and second ends 60B and 60C. The ends 60B and 60C are movably and pivotably mounted and connected securely to the second base 20. The loop clasp 60 is preferably attached to the second base 20 along its side portions 20A and 20B; and proximate, proximal or close to its most forward end 68(or first end). It will be understood that various different types of looped, arced or acuate and/or ringed (or ring-like-shaped) elements, with various shaped configurations can be utilized as the loop clasp 60 of the present invention.

In these related preferred embodiments of the present invention the first end 24 of the first base 18 is provided with the securement groove 70 for receipt and positioning of the loop perimeter 60A; for setting or arming the Hook Setter 10 for use and response to a pressure or tugging from a fish; as described earlier in a similar manner with respect to the clasp 40 and the securement fixture 48.

These embodiments related to the use and facilitation of the loop clasp 60 are similarly utilized and provided with pull members 50, pull-use and mounting fixtures 51 and 51A (and optionable-use fixtures and elements), clasp biasing members 56 and further biasing members 58; in relation to the first and second base members 18 and 20 and the loop clasp 60 and the other elements described earlier; as was the case in the earlier described preferred embodiments of the invention.

In all of the preferred embodiments of the invention the elements 50, 56 and 58 can be utilized in singular respective placement or by virtue of the placement of a plurality of such biasing elements; and, in such use, are utilized preferably in the form of spring members or means; although many other types of biasably and/or tensionable members (designed to exert a force toward movement, etc.) can be utilized within the scope and spirit of the present invention.

As discussed earlier, however, preferred embodiments of the Hook Setter 10 of the present invention are designed to work, at least under certain line tension, or trolling or boat speed, or with regard to the size of fish being sought or actually caught; without any biasing or tensionable members or means; and to function within the present objects and purposes of the present invention on the basis of counter-balancing weight facilitated by the dimensional and weight relationships of the first base 18 in relation to the second base 20 and the positioning of the reel 12C and the rod handle 12D portions of the fishing rod 12 used in interaction with the Hook Setter 10 and its positioning within the placement hole 32 of the first base 18 of the platform assembly 16.

It will be understood by those skilled in the art or technology that it is well within the scope and spirit of the present invention to provide the securement groove 70 in various shapes, configurations and depth-location within the base member; and at positional locations along or near the forward or first end 68 of the second base 20; for engagement and armed or coupleable setting, or temporary positioning, of the loop clasp 60; as shown in part by the different examples of this in the drawing and photographic figures herein.

Accordingly, the appended claims are intended to cover all changes, modifications and alternative options and embodiments falling within the true breath, scope and spirit of the present invention. The Reader is, therefore, requested to determine the scope of the invention by the appended claims and their legal equivalents, and not by the examples which have been given.

I claim:

1. A set device rod holder for hook setting a fish, being used in interaction with a fishing rod having a rod, attached reel and hook, bait or lure-provided fishing line issuing from the reel, and in interaction with an installation surface, said set device rod holder comprising:
a platform assembly having first and second base members, the first base member being hingeably and pivotably coupled to the second base member,
the first base member having first and second ends, a midpoint portion generally therebetween, and first and second planar surfaces,
the first base member defining a placement hole extending between and through the first and second planar surfaces, the placement hole further extending from a position generally proximate to the second end and extending toward the first end thereof, generally disposed along the midpoint portion thereof, for receiving an end or handle portion of a fishing rod for releasable securement thereof;
a prong subassembly means for releasably securing a rod portion of a fishing rod with which it interacts, said prong subassembly means being fixedly secured to the first planar surface of the first base member at a position generally proximate to the first end thereof;
a lengthwise oriented clasp member having first and second planar surfaces and first and second ends, the lengthwise oriented clasp member defining at least one groove portion at a position generally proximate to the second end thereof, and being pivotably and movably attached, at the second end thereof, to the second base member; and
an elongate securement member attached at a position generally proximate to a position between the first end and the midpoint portion of the first base member,
the at least one groove portion of the lengthwise oriented clasp member being selectively positioned to engage and be secured by the elongate securement member;
whereby, when a fish strikes or tugs on a fishing line placed in a water body from a fishing rod secured in the placement hole of the first base member, the groove portion of the lengthwise oriented clasp member is released from the elongate securement member, and the first base member is briskly pulled away from the second base member, hook setting a fish, allowing a user to quickly pick up a fishing rod secured in the placement hole of the first base member and reel in a fishing line.

2. The set device rod holder of claim 1, further comprising, at least one biasing member installably connected, and extending, between the second planar surface of the first base member at a position proximate to the placement hole thereof, and the second base member, for optionally selectable use thereof.

3. The set device rod holder of claim 1, wherein, the placement hole of the first base member generally extends lengthwise at least one-half of the magnitude of length of the first base member, for assisting in a facilitation of counterbalancing the first base member toward the second end of said first base member when an end or handle portion of a fishing rod is received by the placement hole for releasable securement thereof.

4. The set device rod holder of claim 1, wherein the second base member defines an attachment hole for utilization in attaching the second base member to an installation surface with which it interacts.

5. The set device rod holder of claim 1, further comprising a second biasing member, the second biasing member being attached between the lengthwise oriented clasp member and the second base member for biasability therebetween.

6. The set device rod holder of claim 1, further comprising a further biasing member, being attached between the second planar surface of the first base member at a position generally oriented at the midpoint portion thereof and proximate to the placement hole thereof, and the second base member for biasability therebetween.

7. The set device rod holder of claim 1, further comprising a second biasing member, being attached between the lengthwise oriented clasp member and the second base member for biasability therebetween; and a further biasing member, being attached between the second planar surface of the first base member at a position generally oriented at the midpoint portion thereof, and the second base member, for biasability therebetween.

8. The set device rod holder of claim 7, wherein, the lengthwise oriented clasp member defines a biasing member attachment hole for securing a first end of the second biasing member; and the second base member further comprises a securement retention member for securing a second end of the second biasing member.

9. The set device rod holder of claim 8, wherein, the second base member further comprises a securement member for securing a first end of the further biasing member, and the second first base member further comprises a securement member for first base member further comprises a securement member for securing a second end of the further biasing member.

10. The set device rod holder of claim 9, wherein, the second base member further comprises a bolt and nut means, for selective securement and positioning within the attachment hole of the second base member for attachment of the second base member to a preselected installation surface with which the set device rod holder interacts.

11. The set device rod holder of claim 1, wherein, the first base member is in the general configuration of a fish, when viewed from each of the first and second planar surfaces.

12. The set device and rod holder of claim 1, wherein, said second base member has at least first and second ends and first and second planar surfaces.

13. The set device rod holder of claim 12, wherein, the set device rod holder comprises a biased hinge member means for said first base member being hingeably and pivotably coupled to said second base member, said biased hinge member means having first and second flange support members.

14. The set device rod holder of claim 13, wherein, the first flange support member is fixedly attached to the second planar surface of the first base member at a position thereon between the first end and the midpoint portion thereof, generally proximate to the midpoint portion; and the second flange support member is fixedly attached to the second planar surface of the second base member at a position proximal to the second end thereof.

15. A set device rod holder for hook setting a fish, being used in interaction with a conventional fishing rod outfit having a rod, an attached reel, fishing line issuing from the reel and hook, lure, bait or other conventional items at the end of such a fishing line, and in attachable interaction with a convention installation surface such as a tackle box, boat or water shore surface, said set device rod holder comprising:
a platform trap set assembly having first and second base member and means for hingeably and pivotably coupling the first base member in positional relation to the second base member,
the first base member having first and second ends, first and second planar surfaces, and first and second side portions; and the second base member having first and second ends, first and second planar surfaces, and first and second side portions,
the first base member defining a rod handle placement hole extending between and through the first and second planar surface, and having a first end perimeter extending from a position generally proximate to the second end of the first base member, and a second end perimeter extending toward the first end of the first base member;
a biasable and coupleable prong subassembly means for releasably securing a elongate fishing rod portion or other elongate object with which the biasable and coupleable prong subassembly means interacts, said biasable and coupleable prong subassembly means being fixedly attached to the first planar surface of the first base member at a positional orientation generally proximal to the first end of said first base member;
a clasp member defining and having a loop perimeter and first and second ends, the first end thereof being pivotably and movably attached to the first side portion of the second base member and the second end thereof being pivotably and movably attached to the second side portion of the second base member, each of the first and second ends thereof being attached proximal to the first end of the second base member;
the first end of said first base member defining a set groove, for releasable positioning of the loop perimeter of said clasp member for setting the platform trap set assembly for response to a pressure from a fish.

16. The set device rod holder of claim 15, further comprising at least one biasing member being connected, in a first position when being utilized, to extend between the second planar surface of the first base member at a positional orientation proximate to the rod handle placement hole, and the second base member; and being connected, in a second position when not being selected and utilized, to the second base member.

17. The set device rod holder of claim 15, wherein, said means for hingeably and pivotably coupling the first base member in positional relation to the second base member comprises a spring loaded hinge member having first and second flange attachment portions, the first flange attachment portion being fixedly attached to the second planar surface of the first base member, and the second flange attachment portion being fixedly attached to the first planar surface of the second base member.

18. The set device rod holder of claim 17, wherein, the at least one biasing member comprises a resiliently biasing spring member having first and second ends.

19. The set device rod holder of claim 18, wherein, the first end of the resiliently biasing spring member is attached to the first side portion of the second base member, and the second end thereof is attached to the second planar surface of the first base member.

20. The set device rod holder of claim 18, further comprising a further biasing member, positioned and attached to extend between, and biasably pivot towards one another, the second side portion of the second base member and the second planar surface of the first base member.

21. The set device rod holder of claim 15, wherein, the at least one biasing member having first and second ends, the first end being attached to the second planar surface of the first base member, and the second end being attached to the first side portion of the second base member.

22. The set device rod holder of claim 21, further comprising a further biasing member having first and second ends, the first end being attached to the second planar surface of the first base member, and the second end being attached to the second side portion of the second base member.

23. A releasably setable device rod holder and automatic fish catching device, for support and interaction with a conventional fishing rod outfit for use in water areas, and counterbalanceably engaging such a supported fishing rod outfit for the functional purposes of hook setting a game fish that strikes or pulls on a fishing line in a game water area, said releasably setable device rod holder and automatic fish catching device comprising:
a counterbalanceable platformed trap set assembly having first and second base members and means for hingeably and pivotably connecting and moving the first base member in positional relation to the second base member,
the first base member having at least first and second ends, first and second surfaces and first and second side portions; and the second base member having at least first and second ends, first and second surfaces and first and second side portions,
the first base member defining and having a rod placement hole extending between the first and second surfaces thereof;
means for releasably and biasably retaining an elongate object therewithin, said means comprising first and second prong members, each being pivotably biased and coupled in relation to one another, said means being fixedly attached to the first surface of the first base member;
a clasp member defining and having at least one looped portion and first and second ends, said clasp member being pivotably and movably mounted on the second base member; and
means for setably and releasably receiving the clasp member, said means being positioned on the first base member generally proximate to the first end and first and second surfaces thereof;
the second base member further defining means for securing the second base member to a selected installment surface with which the releasably biasable set device rod holder and automatic fish catching device interacts.

24. The releasably setable device rod holder and automatic fish catching device of claim 23, further comprising at least one biasing member having a biasable force, biasably connecting and extending between the first base member and the first side portion of the second base member, said second base member having means for optionally installing the at least one biasing member thereon for selected inactive storage, non-use and non-engagement when it is desired by a user not to utilize and employ the biasing force of the at least one biasing member.

25. The releasably setable device rod holder and automatic fish catching device of claim 23, wherein, said means for hingeably and pivotably connecting and moving the first base member in positional relation to the second base member, comprises a spring set and biased hinge member, having biasing force, connected between, and coupling, the first base member and the second base member, so as to exert the biasing force to move the first an second base members away from one another.
